(19) United States
(12) Patent Application Publication
(10) Pub. No.: US 2026/0209411 A1
(43) Pub. Date: Jul. 23, 2026

(54) WATERBORNE POLYMER COMPOSITION AND PREPARATION METHOD THEREOF

(71) Applicants: ORGANIK KIMYA SANAYI VE TIC. A.S., Istanbul (TR); ORGANIK KIMYA NETHERLANDS BV, Botlek Rotterdam (NL)

(72) Inventors: Nur Basak ERGUN ERSEN, Istanbul (TR); Mehmet DEMIRAY, Istanbul (TR)

(21) Appl. No.: 19/133,853

(22) PCT Filed: Dec. 15, 2023
(86) PCT No.: PCT/EP2023/086182

§ 371 Date: May 29, 2025

(30) Foreign Application Priority Data
Dec. 16, 2022 (EP) 22214092.3
Aug. 4, 2023 (EP) 23189870.1

(51) Int. Cl. C08F 212/08; C08F 2/00; C08F 2/26; C08F 2/30; C08J 11/12; C09D 125/06

(52) U.S. Cl. CPC C08F 212/08; C08F 2/001; C08F 2/26; C08F 2/30; C08J 11/12; C09D 125/06; C08J 2325/06

(57) ABSTRACT

The present invention relates to waterborne polymer compositions comprising a polymer obtained with recycled monomers, said recycled monomers being recycled styrene comprising specific chemical compounds at specific levels. The present invention also relates to a process for producing said polymer composition. The use of the waterborne polymer compositions in coating, paint, primer, ink, pressure sensitive adhesive, textile and leather additive, paper additive, constructions additive, or varnish is also a part of the present invention.

### TECHNICAL DOMAIN OF THE INVENTION

The present invention relates to waterborne polymer compositions comprising a polymer obtained with recycled monomers, said recycled monomers being recycled styrene and comprising specific chemical compounds at specific levels. The present invention also relates to a process for producing said polymer composition. The use of the waterborne polymer compositions in coating, paint, primer, ink, pressure sensitive adhesive, textile and leather additive, paper additive, constructions additive, or varnish is also a part of the present invention.

### BACKGROUND OF THE INVENTION

One of the most important challenges of the 21st century is reducing the amount of residues produced by humans. Plastic and polymer production has grown faster than any other material since the 1950s. Polymers can be recycled but only a small part of plastic and polymer is effectively recycled. For some compound the recycling process is well-known and efficient at industrial scale.

Therefore, it is desirable to use recycled monomer to produce more sustainable polymers. But generally, the recycling process produce recycled monomer comprising high level of impurities, generally higher than in the corresponding virgin monomer.

The problem is that the impurities present in the recycled monomers, especially when their concentration is high, affects the technical performances of the polymer made with said recycled monomers. More the impurity level is high, higher is the deterioration of the performances of the resulting polymer. The reason is that the impurities are harmful to the polymerization of monomers.

To solve this problem the recycling process of polymers includes a purification step to avoid the contamination of recycled monomer with impurities and to decrease as much as possible the level of impurities contained in the recycled monomer. Different purification processes have been developed to reach this goal. But the purification process represents an additional step in the recycling process that induces cost increase and energy consumption.

It is desirable to find new solutions for example improved depolymerization process allowing the production of recycled monomers having the same purity, in other terms the same low level of impurities, as the virgin monomers.

Nevertheless, the problem of high level of impurity is still a problem for the reuse of recycled monomers because the impurities deteriorate the technical performances of the polymers.

It would therefore have been expected that the polymerization of recycled monomers comprising a high level of impurities, for example because not purified, would lead to polymers with degraded properties.

However, against all expectations, the Applicant has discovered that it was possible to use recycled monomers, preferably recycled styrene containing a substantial amount of specific impurities at specific levels, to obtain polymers having substantially the same performances, and in some extend better performances, when compared to polymers obtained with virgin monomers.

### SUMMARY OF THE INVENTION

The present invention relates to a waterborne polymer composition comprising a polymer obtained from recycled styrene containing specific impurity at specific level. The present invention also relates to a process for producing a waterborne polymer composition with said recycled styrene, preferably by emulsion polymerization, more preferably by multistage emulsion polymerization. The invention also relates to the use of said composition in coating, textile, pressure sensitive adhesive, construction, and leather applications.

### DETAILED DESCRIPTION OF THE INVENTION

The present invention relates to a waterborne polymer composition comprising a polymer obtained from 1 to 100% by weight of at least one recycled monomer, wherein said recycled monomer is recycled styrene, or its dimer, or its trimer, and comprises from 100 ppm to 25.000 ppm by weight of ethylbenzene.

Generally, the recycling of polystyrene leads to the production of about 60-65% by weight of styrene, 20-25% by weight of its dimers and 10-15% by weight of its trimers. The expression “recycled styrene, or its trimer, or its dimer” means that the recycled styrene may comprises a mixture of recycled styrene, in combination with its recycled dimer and/or trimer. This combination, or composition depends on the recycling process.

The waterborne polymer composition is preferably an emulsion in which the polymer is present in particulates form in dispersion in an aqueous medium. The waterborne polymer composition preferably comprises from 0.3 to 67% by weight, more preferably from 1.5 to 50%, even more preferably from 5 to 30% by weight of polymer of the invention obtained from at least recycled styrene comprising from 100 ppm to 25.000 ppm by weight of ethylbenzene.

The invention concerns a process for producing a waterborne polymer composition by emulsion polymerization comprising the polymerization from 1 to 100% by weight of at least one recycled monomer, wherein said recycled monomer is recycled styrene, or its dimer, or its trimer, and comprises from 100 ppm to 25.000 ppm by weight of ethylbenzene. The emulsion may be a single stage polymerization or a multistage polymerization. The emulsion polymerization is preferably a multistage emulsion polymerization.

According to the invention, it is surprisingly possible to obtain polymer emulsion with recycled styrene, without affecting the performances of the polymer, especially in certain technical domain such as coating. It is therefore possible to obtain polymers having satisfactory performances, and in some extend better performances, even with recycled styrene comprising a high level of specific impurities.

The present invention proposes a new way to obtain good performances polymers made with recycled styrene, with the possibility to avoid an additional step to decrease the impurity levels in said recycled styrene.

### The Recycled Monomer

The general term “recycled monomers” as used herein and throughout the specification is intended to refer to the recovered monomers from recycling process, generally after the recycling process of a polymer.

In the present invention, the at least one recycled monomer is recycled styrene that comprises specific impurities present in a specific amount.

The recycled styrene, or its dimer, or its trimer also preferably comprises from 100 ppm to 25.000 ppm by weight of ethylbenzene, preferably from 150 ppm to 15.000 ppm, more preferably from 200 ppm to 10.000 ppm, even more preferably from 300 ppm to 8.000 ppm, even more preferably from 400 ppm to 5.000 ppm, even more preferably from 500 ppm to 3.000 ppm, even more preferably from 600 ppm to 2.000 ppm.

The recycled styrene, or its dimer, or its trimer also preferably comprises from 150 ppm to 25.000 ppm by weight of cumene, preferably from 200 ppm to 15.000 ppm, more preferably from 300 ppm to 10.000 ppm, even more preferably from 400 ppm to 8.000 ppm, even more preferably from 500 ppm to 7.000 ppm, even more preferably from 600 ppm to 5.000 ppm, even more preferably from 700 ppm to 3.000 ppm, even more preferably from 800 ppm to 2.000 ppm.

The recycled styrene, or its dimer, or its trimer also preferably comprises from 400 ppm to 15.000 ppm by weight of xylene, preferably from 500 ppm to 12.000 ppm, more preferably from 600 ppm to 10.000 ppm, even more preferably from 700 ppm to 8.000 ppm, even more preferably from 800 ppm to 6.000 ppm, even more preferably from 900 ppm to 5.000 ppm, even more preferably from 1000 ppm to 4.000 ppm, even more preferably from 1100 ppm to 3.500 ppm, even more preferably from 1200 ppm to 3.000 ppm, even more preferably from 1300 to 2.500 ppm, even more preferably from 1400 ppm to 2.000 ppm.

As a matter of clarification, in the present invention, the xylene comprises the ortho xylene, the meta xylene, and the para xylene.

The recycled styrene, or its dimer, or its trimer also preferably comprises from 10 ppm to 3.000 ppm by weight of toluene, preferably from 20 ppm to 1.500 ppm, more preferably from 50 ppm to 1.000 ppm, even more preferably from 100 ppm to 800 ppm, even more preferably from 200 ppm to 600 ppm.

The recycled styrene, or its dimer, or its trimer comprises from 10 ppm to 3.000 ppm by weight of benzene, preferably from 20 ppm to 1.500 ppm, more preferably from 50 ppm to 1.000 ppm, even more preferably from 100 ppm to 800 ppm, even more preferably from 200 ppm to 600 ppm.

The recycled styrene, or its dimer, or its trimer also preferably comprises from 1 ppm to 5.000 ppm by weight of 2,4,6-triphenyl-1-hexene, preferably from 5 ppm to 2.000 ppm, more preferably from 25 ppm to 1.000 ppm, even more preferably from 50 ppm to 800 ppm, even more preferably from 70 ppm to 600 ppm, even more preferably from 100 ppm to 500 ppm, even more preferably from 150 ppm to 400 ppm.

The recycled styrene, or its dimer, or its trimer also preferably comprises from 1 ppm to 5.000 ppm by weight of 2,4-diphenyl-1-butene, preferably from 5 ppm to 2.000 ppm, more preferably from 25 ppm to 1.000 ppm, even more preferably from 50 ppm to 800 ppm, even more preferably from 70 ppm to 600 ppm, even more preferably from 100 ppm to 500 ppm, even more preferably from 150 ppm to 400 ppm.

The recycled styrene, or its dimer, or its trimer also preferably comprises from 70 ppm to 5.000 ppm by weight of vinyl toluene, preferably from 90 ppm to 2.000 ppm, more preferably from 100 ppm to 1.000 ppm, even more preferably from 120 ppm to 800 ppm, even more preferably from 140 ppm to 600 ppm, even more preferably from 170 ppm to 500 ppm, even more preferably from 200 ppm to 400 ppm.

The recycled styrene, or its dimer, or its trimer also preferably comprises from 1 ppm to 5.000 ppm by weight of 1,3-diphenylpropane, preferably from 5 ppm to 2.000 ppm, more preferably from 25 ppm to 1.000 ppm, even more preferably from 50 ppm to 800 ppm, even more preferably from 70 ppm to 600 ppm, even more preferably from 100 ppm to 500 ppm, even more preferably from 150 ppm to 400 ppm.

The recycled styrene, or its dimer, or its trimer also preferably comprises from 200 ppm to 25.000 ppm by weight of alpha-methyl styrene, preferably from 300 ppm to 15.000 ppm, more preferably from 500 ppm to 10.000 ppm, even more preferably from 1000 ppm to 8.000 ppm, even more preferably from 1200 ppm to 5.000 ppm, even more preferably from 1400 ppm to 3.000 ppm, even more preferably from 1500 ppm to 2.000 ppm.

The recycled styrene or its dimer or its trimer preferably comprises 100 ppm to 25.000 ppm by weight of ethylbenzene, and at least one compound, preferably at least two, more preferably at least three, more preferably at least four, more preferably at least five, even more preferably at least six, even more preferably at least seven, even more preferably at least height compounds selected from the list comprising cumene, xylene (ortho, meta, para), toluene, benzene, 2,4,6-triphenyl-1-hexene, 2,4-diphenyl-1-butene, vinyl toluene, 1,3-diphenylpropane, alpha-methyl styrene, the amount of said compounds being selected from the respecify ranges described above.

The recycled styrene or its dimer or its trimer preferably comprises 100 ppm to 25.000 ppm by weight of ethylbenzene, and from 150 ppm to 25.000 ppm by weight of cumene, from 400 ppm to 15.000 ppm by weight of xylene (ortho, meta, para), from 10 to 3.000 ppm by weight of toluene, from 10 ppm to 3.000 ppm by weight of benzene, from 1 ppm to 5.000 ppm by weight of 2,4,6-triphenyl-1-hexene, from 1 ppm to 5.000 ppm by weight of 2,4-diphenyl-1-butene, from 70 ppm to 5.000 ppm by weight of vinyl toluene, from 1 ppm to 5.000 ppm by weight of 1,3-diphenylpropane, and from 200 ppm to 25.000 ppm by weight of alpha-methyl styrene,

The determination of the amount of impurities in the recycled monomers is made by gas chromatography analysis. A non-limiting example of gas chromatography device that can be used for this purpose is Agilent 7890B with headspace Agilent 7697A and mass detector Agilent 5977B. The skilled man of the art knows how to determine the amount of an impurity in a sample with known gas chromatography method.

The recycled styrene is generally obtained via chemical recycling of polystyrene (PS).

Thermal cracking or pyrolysis process including the degradation of the polymeric material by heating under inert atmosphere is employed in chemical recycling of PS. Thermal decomposition of PS to styrene takes place at temperatures above ceiling temperature where the rate of propagation is equal to the rate of depropagation.

The recycled styrene is obtained by a recycling process, generally after the recycling process of a polymer. In the present invention, the recycled styrene is preferably obtained by a recycling process that does not comprise a purification step. In the present invention the term “purification step” means an additional process step in which the amount of impurities present in the recycled styrene is decreased compare to the amount of impurities present in the recycled styrene directly obtained from the recycling process, for example the depolymerization of polymers.

In other terms the recycled styrene used in the present invention is preferably not purified in a purification step. The recycled monomer used in the invention preferably comprises the impurities present at the end of the recycling process, and without an additional purification step.

### The Polymer

The polymer of the invention is preferably obtained:
from 1 to 100% by weight of at least one recycled styrene, or its dimer, or its trimer, comprising from 100 ppm to 25.000 ppm by weight of ethylbenzene;
optionally from 0.1 to 50% by weight of at least one additional monomer;
optionally from 0.1 to 50% by weight of at least one biobased monomer.

The polymer of the invention is preferably obtained:
from 1 to 99.9% by weight of at least one recycled styrene, or its dimer, or its trimer, comprising from 100 ppm to 25.000 ppm by weight of ethylbenzene;
from 0.1 to 50% by weight of at least one additional monomer;
optionally from 0.1 to 50% by weight of at least one biobased monomer.

The polymer of the invention is preferably obtained:
from 1 to 99.8% by weight of at least one recycled styrene, or its dimer, or its trimer comprising from 100 ppm to 25.000 ppm by weight of ethylbenzene;
from 0.1 to 50% by weight of at least one additional monomer;
from 0.1 to 50% by weight of at least one biobased monomer having a biobased carbon content between 10% by weight and 100% by weight relative to the total weight of carbon of said monomer, the biobased carbon content being measured according to ASTM D6866-22 Standard.

The polymer of the invention is preferably obtained from 2.5 to 95% of at least a recycled styrene or its dimer or its trimer, more preferably from 5 to 85%, even more preferably from 10 to 80%, even more preferably from 15 to 70% by weight.

The recycled styrene may also preferably comprise at least one other impurity from the following list cumene, xylene (ortho, meta, para), toluene, benzene, 2,4,6-triphenyl-1-hexene, 2,4-diphenyl-1-butene, vinyl toluene, 1,3-diphenylpropane, alpha-methyl styrene, the amount of said impurity being selected from the respecify ranges described above.

The waterborne polymer composition may contain from 50 ppm to 18.800 ppm by weight of ethylbenzene. It may contain from 50 to 18800 ppm by weight of cumene. It may contain from 100 to 4500 ppm by weight of xylene (ortho, meta, para). It may contain from 5 to 1000 ppm by weight of toluene. It may contain 5 to 1000 ppm by weight of benzene. It may contain from 1 to 3800 ppm by weight of 2,4,6-triphenyl-1-hexene. It may contain from 1 to 3800 ppm by weight of 2,4-diphenyl-1-butene. It may contain from 1 to 500 ppm by weight of vinyl toluene. It may contain from 1 to 3800 ppm by weight of 1,3-diphenylpropane. It may contain from 1 to 18800 ppm by weight of alpha-methyl sytrene.

When the waterborne composition is dried to obtained the polymer itself, also called the final polymer. The final polymer may contain from 50 ppm to 18.800 ppm by weight of ethylbenzene. It may contain from 50 to 18800 ppm by weight of cumene. It may contain from 100 to 4500 ppm by weight of xylene (ortho, meta, para). It may contain from 5 to 1000 ppm by weight of toluene. It may contain 5 to 1000 ppm by weight of benzene. It may contain from 1 to 3800 ppm by weight of 2,4,6-triphenyl-1-hexene. It may contain from 1 to 3800 ppm by weight of 2,4-diphenyl-1-butene. It may contain from 1 to 500 ppm by weight of vinyl toluene. It may contain from 1 to 3800 ppm by weight of 1,3-diphenylpropane. It may contain from 1 to 18800 ppm by weight of alpha-methyl sytrene.

The polymer of the invention may also comprise a second recycled monomer, preferably a recycled methyl methacrylate comprising from 200 ppm to 30.000 ppm by weight of methyl isobutyrate. The recycled methyl methacrylate may also advantageously comprise from 1 ppm to 15.000 ppm by weight of comprises methylacrylate, and/or from 100 ppm to 10.000 ppm by weight of methyl propanoate, and/or from 1 ppm to 15.000 ppm by weight of ethyacrylate, and/or from 1 ppm to 15.000 ppm by weight of methyl pivalate.

The polymer of the invention is preferably obtained from 5% to 97.5% by weight of at least one additional monomer, more preferably from 30% to 85% by weight.

According to the invention, additional monomers mays be chosen from the list comprising ethylenically unsaturated monomers preferably selected from the list comprising alkyl acrylates or alkyl methacrylates such as linear, branched or cycloaliphatic Ci-C22-alkyl(meth)acrylates, methyl(meth)acrylate, ethyl(meth)acrylate, n-butyl(meth)acrylate, isobutyl-(meth)acrylate, lauryl(meth)acrylate, 2-ethylhexyl(meth)acrylate, stearyl-(meth)acrylate, cyclohexyl(meth)acrylate, isobornyl(meth)acrylate, 2-octyl-(meth)acrylate and tert-butyl(meth)acrylate, aryl(meth)acrylates, benzyl(meth)acrylate and phenyl(meth)-acrylate, tetrahydrofurfuryl(meth)acrylate, methoxyethoxyethyl(meth)-acrylate, 1-butoxypropyl(meth)acrylate, cyclohexyloxymethyl(meth)acrylate, methoxymethoxyethyl(meth)acrylate, benzyloxymethyl(meth)acrylate, furfuryl-(meth)acrylate, 2-butoxy ethyl (meth)acrylate, 2-ethoxyethyl(meth)acrylate, allyloxymethyl(meth)acrylate, 1-ethoxybutyl(meth)acrylate, 1-ethoxyethyl-(meth)acrylate, ethoxymethyl(meth)acrylate, poly(ethyleneglycol)methyl-ether(meth)acrylate, and poly(propyleneglycol) methylether (meth)acrylate or aminoalkyl(meth)acrylates such as N,N-dimethyl aminoethyl (meth)acrylate, 2-trimethylammoniumethyl(meth)acrylatchloride and N,N-dimethyl amino-propyl(meth)acrylate, oxiranyl(meth)acrylates such as 2,3-epoxy butyl(meth)acrylate, 3,4-epoxy-butyl(meth)acrylate and glycidyl(meth)acrylate, styrenes, substituted styrenes such as a-methylstyrenes, 4-methylstyrenes, 4-vinylbenzoic acid and sodium-4-vinylbenzene sulfonate, vinylesters of carboxylic acids comprising 1 to 20 carbon atoms, especially vinylacetate, vinylesters of versatic acids such as VeoVa-10, 10 (meth)acrylamides, acid functional monomers such as acrylic acid, methacrylic acid, itaconic acid, crotonic acid, fumaric acid, n-butylacrylic acid, iso-butylacrylic acid, laurylacrylic acid, 2-ethylhexylacrylic acid, stearylacrylic acid, cyclohexylacrylic acid, isobornylacrylic acid and tert-butylacrylic acid.

In a preferred mode, the least one additional monomer is carboxyl functional monomer, said carboxyl functional monomer being preferably chosen from the group comprising acrylic acid, methacrylic acid, crotonic acid, maleic acid, itaconic acid, mesaconic acid, fumaric acid, methylenemalonic acid, citraconic acid or mixtures thereof.

The polymer of the invention is preferably obtained from 0 to 70% by weight of at least one biobased monomer, more preferably from 5 to 50% by weight.

According to the invention, the biobased monomer is at least partially of renewable and non-fossil sources. According to the invention, the expression “at least partly of renewable and non-fossil sources” means that the biobased monomer has a biobased carbon content preferably between 10% by weight and 100% by weight relative to the total weight of carbon of said monomer.

The biobased carbon content is measured according to ASTM D6866-22 Standard.

In the context of the invention, the ASTM D6866-22 standard is used to characterize the biobased nature of a chemical compound, and to determine the biobased carbon content of said compound. The value is expressed as a percentage by weight of biobased carbon relative to the total weight of carbon in said compound.

ASTM D6866-22 is a test method that teaches how to experimentally measure the bio-based carbon content of solids, liquids, and gaseous samples by radiocarbon analysis.

This standard mainly uses the technology of the AMS (Accelerator Mass Spectrometry). This technique is used to naturally measure the radionuclides present in a sample, in which the atoms are ionized, then accelerated to high energies, then separated, and individually counted in Faraday collectors. This high-energy separation is extremely effective at filtering out isobaric interference, so the AMS is able to accurately measure the abundance of carbon-14 by compared to carbon 12 (14C/12C) to an accuracy of 1.10⁻¹⁵.

This standard makes it possible to directly distinguish carbon atoms from contemporary carbon from carbon atoms of fossil origin.

The biobased monomer has preferably a biobased carbon content comprised between 20% by weight and 100% by weight relative to the total weight of carbon of said monomer, more preferably more than 30%, even more preferably more than 50%, even more preferably more than 70%, even more preferably more than 90% by weight. In a preferred mode of the invention the biobased monomer has a biobased carbon content of 100% by weight.

The biobased monomer is preferably chosen from the list comprising ethylacrylate, lauryl (meth)acrylate, iso-bornyl (meth)acrylate, tetrahydrafurfuyl (meth)acrylate, stearyl acrylate, n-octyl acrylate, n-butyl methacrylate, methyl methacrylate, vanillin methacrylate, neopentyl glycol diacrylate, trimethyloyl propane triacrylate, pentaerythritol tetraacrylate, dipentaerythritol pentaacrylate.

The biobased monomer is more preferably ethylacrylate, lauryl (meth)acrylate, or a mixture thereof.

The polymer of the waterborne polymer composition of the invention has preferably a weight average molecular weight within the range of 100.000 to 20 million Daltons, preferably within the range of 200.000 to 10 million, more preferably within the range of 500.000 to 5 million Daltons.

The weight average molecular weights of polymeric stabilizers are determined by Gel Permeation Chromatography (GPC). It is for example determined using a device such as Jasco 2000 series Gel Permeation Chromatography (GPC) coupled with differential refractive index detector and following the exemplified but not limiting method. The sample is dissolved in THE at a concentration of 5 mg/mL and filtered through 0.45 μm PTFE filter. 30 μL of the polymer solution are injected into the system. The separation is performed in THE at a constant flow rate of 1 mL/min and at 40° C. using three styrene-divinyl benzene columns (300 mm×8 mm I.D.) in series each with particle size of 5 m and porosity of 1000, 100000 and 1000000 Å, respectively. A guard column (30 mm×8 mm) with particle size of 5 m is included before the analytical columns. Calibration is performed using a series of polystyrene standards from 580 to 3′200′000 g/mol. The molar masses obtained are either an interpolation or an extrapolation from the calibration curve.

### The Waterborne Polymer Composition

The waterborne polymer composition according to the invention comprises from 10 to 100% by weight of polymer according to the invention, preferably from 15 to 80%, more preferably from 20 to 70% by weight, even more preferably from 30 to 60% by weight.

The waterborne polymer composition of the invention may be an emulsion, a latex, a dispersion, or a solution. It's preferably an emulsion or a latex. When the waterborne composition is an emulsion or a latex, it comprises the polymer and, an oil and/or a solvent, and at least one surfactant and/or at least one polymeric stabilizer and/or at least one colloidal stabilizing agents, and/or at least one polymerizable surfactant. The waterborne polymer composition is preferably an emulsion.

The waterborne polymer composition of the invention may be dried to obtain a polymer powder. Drying may be done by spraydrying. In a particular embodiment, the polymer powder is a redispersible polymer powder.

Suitable protective colloids could be polyvinyl alcohols, poly ethylene glycol, poly vinylpyrrolidone, celluloses such as hydroxyethyl cellulose, hydroxy propyl cellulose and carboxymethyl cellulose, starches and dextrins, cyclodextrins, homopolymers and copolymers of acrylamidopropanesulfonic acid.

Suitable polymerizable surfactants could be E-Sperse® RS-1596, E-Sperse® RS-1684, E-Sperse® RS-1616, E-Sperse® RS-1617, E-Sperse® RX-202, E-Sperse® RS-1618, MAXEMUL 5011, MAXEMUL 6106, MAXEMUL 6112, LATEMUL PD-420, LATEMUL PD-430, LATEMUL PD-430S, LATEMUL PD-450, Sipomer COPS 1, Sipomer PAM 200, Sipomer PAM 4000, VISIOMER® MPEG 750 MA W, Emulsogen APS 100, Emulsogen RAL 100, Emulsogen RAL 109, Emulsogen RAL 307, Emulsogen RAL 208, Emulsogen APS 2019, Emulsogen APS 100S, Hitenol BC-10, Hitenol BC-1025, Hitenol BC-20, Hitenol BC-30, Hitenol AR-10, Hitenol AR-20, Hitenol KH-Series, Reasoap ER-10, Reasoap ER-20, Reasoap ER-30, Reasoap ER-40, Reasoap SR-10, Reasoap SR-20, Reasoap SR-1025, Reasoap SR-3025, Reasoap SE-10N, Reasoap NES-60N.

The surfactant may be an anionic, non-ionic, cationic, zwitterionic and polymerizable surfactant, especially selected from the group consisting of anionic organic sulfates and sulfonates and non-ionic alkylene oxides, especially ethylene and/or propylene oxides and combinations thereof, preferably selected from the group consisting of organic sulfonates, particularly dodecyl diphenyloxide disulfonates, more particularly sodium dodecyl sulfate, and polymerizable surfactants (surfmers), especially (meth)acrylate, allyl, alkyl, styrenic, maleate, fumarate, crotonate, allyloxy and acrylamide functional groups containing anionic and non-ionic polymerizable surfactants, preferably, ammonium polyoxyalkylene alkenylether sulfates (e.g. Latemul PD-104, Kao Corporation), phosphate esters of polyalkylene monomethacrylates (e.g. Sipomer PAM 200, Solvay), polyoxyethylene styrenated propenyl phenyl ether sulfate ammonium salts (e.g. HITENOL AR series, DKS surfactants), polyoxyethylene-1-(allyloxymethyl) alkyl ether sulfate ammonium salts (e.g. HITENOL KH series, DKS surfactants), polyoxyethylene-1-(allyloxymethyl) alkyl ethers (e.g., NOIGEN KN series, DKS surfactants), polyoxyethylene styrenated propenyl phenyl ethers (e.g., NOIGEN AN series, DKS surfactants).

Appropriate surfactants, could also be anionic surfactants, such as e.g. alkyl, alkyl phenyl or styrenated phenyl sulfates and sulfonates, especially sodium dodecyl sulfate, or polymerizable anionic surfactants containing sulfates and sulfonates together with allyl, propenyl and propenyl phenyl polymerizable groups, or polymerizable non-ionic surfactants with hydrophilic part containing ethylene oxide or propylene oxide groups or mixtures of both together with polymerizable groups like allyl, propenyl and propenyl phenyl.

Suitable cationic surfactants could be benzalkonium chloride, cetylpyridinium, benzethonium chloride, alkyltrimethylammonium salts such as cetyl trimethylammonium bromide, and cetyl trimethylammonium chloride, lauryl trimethyl ammonium chloride, C.C.C7-trimethyl ammonium bromides, halide salts of quaternized polyoxyethylalkylamines, dodecylbenzyl tri ethyl ammonium chloride, MIRAPOL® and ALKAQUATR (available from Alkaril Chemical Company) or SANIZOL® (benzalkonium chloride, available from Kao Chemicals). Suitable zwitterionic surfactants could be cholamidopropyl)dimethylammonio]-1-propanesulfonate) and betaines such as cocamidopropyl betaine have a carboxylate with the ammonium.

The waterborne polymer composition may contain from 50 ppm to 18.800 ppm by weight of ethylbenzene. It may contain from 50 to 18800 ppm by weight of cumene. It may contain from 100 to 4500 ppm by weight of xylene (ortho, meta, para). It may contain from 5 to 1000 ppm by weight of toluene. It may contain 5 to 1000 ppm by weight of benzene. It may contain from 1 to 3800 ppm by weight of 2,4,6-triphenyl-1-hexene. It may contain from 1 to 3800 ppm by weight of 2,4-diphenyl-1-butene. It may contain from 1 to 500 ppm by weight of vinyl toluene. It may contain from 1 to 3800 ppm by weight of 1,3-diphenylpropane. It may contain from 1 to 18800 ppm by weight of alpha-methyl sytrene.

The waterborne polymer composition of the invention preferably comprises from 50 ppm to 18.800 ppm by weight of ethylbenzene, preferably from 75 ppm to 10.000 ppm, more preferably from 100 ppm to 8.000 ppm, even more preferably from 150 ppm to 5.000 ppm, even more preferably from 200 ppm to 2500 ppm, even more preferably from 250 ppm to 1000 ppm, even more preferably from 300 ppm to 800 ppm.

The waterborne polymer composition of the invention preferably comprises from 50 ppm to 18.800 ppm by weight of cumene, preferably from 75 ppm to 10.000 ppm, more preferably from 100 ppm to 8.000 ppm, even more preferably from 150 ppm to 5.000 ppm, even more preferably from 200 ppm to 2.500 ppm, even more preferably from 250 ppm to 1.000 ppm, even more preferably from 300 ppm to 800 ppm.

The waterborne polymer composition of the invention preferably comprises from 100 ppm to 4.500 ppm by weight of xylene, preferably from 125 ppm to 4.000 ppm, more preferably from 150 ppm to 3.800 ppm, even more preferably from 180 ppm to 3.500 ppm, even more preferably from 200 ppm to 3.000 ppm, even more preferably from 220 ppm to 2.500 ppm, even more preferably from 250 ppm to 2.000 ppm, even more preferably from 280 ppm to 1.500 ppm, even more preferably from 300 ppm to 1.000 ppm.

As a matter of clarification, in the present invention, the xylene comprises the ortho xylene, the meta xylene, and the para xylene.

The waterborne polymer composition of the invention preferably comprises from 5 ppm to 1.000 ppm by weight of toluene, preferably from 10 ppm to 800 ppm, more preferably from 11 ppm to 500 ppm, even more preferably from 12 ppm to 350 ppm, even more preferably from 13 ppm to 250 ppm.

The waterborne polymer composition of the invention preferably comprises from 5 ppm to 1.000 ppm by weight of benzene, preferably from 10 ppm to 800 ppm, more preferably from 14 ppm to 600 ppm, even more preferably from 16 ppm to 500 ppm, even more preferably from 20 ppm to 500 ppm.

The waterborne polymer composition of the invention preferably comprises from 1 ppm to 3.800 ppm by weight of 2,4,6-triphenyl-1-hexene, preferably from 2 ppm to 2.500 ppm, more preferably from 3 ppm to 1500 ppm, even more preferably from 5 ppm to 1000 ppm, even more preferably from 8 ppm to 800 ppm, even more preferably from 10 ppm to 500 ppm, even more preferably from 13 ppm to 200 ppm.

The waterborne polymer composition of the invention preferably comprises from 1 ppm to 3.800 ppm by weight of 2,4-diphenyl-1-butene, preferably from 2 ppm to 1.500 ppm, more preferably from 3 ppm to 1.000 ppm, even more preferably from 4 ppm to 800 ppm, even more preferably from 5 ppm to 500 ppm, even more preferably from 6 ppm to 300 ppm.

The waterborne polymer composition of the invention preferably comprises from 1 ppm to 500 ppm by weight of vinyl toluene, preferably from 2 ppm to 400 ppm, more preferably from 3 ppm to 250 ppm, even more preferably from 4 ppm to 200 ppm, even more preferably from 5 ppm to 150 ppm.

The waterborne polymer composition of the invention preferably comprises from 1 ppm to 3.800 ppm by weight of 1,3-diphenylpropane, preferably from 2 ppm to 3.200 ppm, more preferably from 3 ppm to 1.000 ppm, even more preferably from 4 ppm to 750 ppm.

The waterborne polymer composition of the invention preferably comprises from 1 ppm to 18.800 ppm by weight of alpha-methyl styrene, preferably from 2 ppm to 10.000 ppm, more preferably from 3 ppm to 5.000 ppm, even more preferably from 4 ppm to 2.000 ppm, even more preferably from 5 ppm to 1.000 ppm, even more preferably from 6 ppm to 500 ppm, even more preferably from 7 ppm to 300 ppm.

The above impurities present in the waterborne polymer composition comes or derived from the recycled styrene according to the invention, used to make said waterborne polymer composition. For example, an emulsion A (the waterborne polymer composition) comprising 50% by weight of polymer made with recycled styrene comprising 1000 ppm of ethylbenzene, said emulsion A comprises 500 ppm of ethylbenzene. Another example is an emulsion B (the water-borne polymer composition) comprising 50% by weight of polymer made with recycled styrene comprising 1000 ppm of ethylbenzene, and a comonomer, methylmethacrylate (mass ratio between methyl methacrylate and styrene 1:1), said emulsion B comprises 250 ppm of ethylbenzene.

### Emulsion Polymerization Process

The waterborne polymer composition is preferably obtained by emulsion polymerization. The waterborne polymer composition is preferably an emulsion. The waterborne polymer composition preferably comprises from 0.3% to 67% % by weight of polymer obtained from at least recycled styrene comprising from 100 ppm to 25.000 ppm by weight of ethylbenzene.

The Applicant has discovered that this method of polymerization is particularly advantageous to obtain polymers with recycled styrene containing a substantial amount of specific impurities at specific levels, said polymers having substantially the same performances and properties than the polymers made with virgin monomers, and in some extend better performances.

Emulsion polymerization is a type of free radical polymerization process which generally starts with an emulsion incorporating water, at least one monomer and at least one surfactant. The polymerization is generally initiated with a polymerization initiator. The resulting polymers produced in such a way are polymer particles dispersed in the water phase.

By emulsion polymerization we preferably exclude the inverse emulsion polymerization.

In the emulsion polymerization process described hereafter, the recycled styrene or its dimer, or its trimer, comprises from 100 ppm to 25.000 ppm by weight of ethylbenzene, and may also preferably comprises at least one other impurity form the following list: cumene, xylene (ortho, meta, para), toluene, benzene, 2,4,6-triphenyl-1-hexene, 2,4-diphenyl-1-butene, vinyl toluene, 1,3-diphenylpropane, alpha-methyl styrene, the amount of said impurity being selected from the respecify ranges described above.

The waterborne Polymer composition of the invention is preferably obtained by an emulsion polymerization process comprising:
a. Preparing a mixture comprising at least one surfactant and/or at least one polymeric stabilizer, and/or at least one stabilizing agent, and at least one recycled styrene, or its dimer, or its trimer, comprising from 100 ppm to 25.000 ppm by weight of ethylbenzene;
b. Initiating the polymerization;
c. Obtaining a polymer emulsion.

In a first aspect of the invention, the emulsion polymerization is made in the presence of at least one surfactant.

According to this first aspect, the waterborne polymer composition of the invention is preferably obtained by a multistage emulsion polymerization process comprising:
a. a first stage comprising the polymerization of a mixture comprising:
   i. water;
   ii. at least one surfactant;
   iii. at least one ethylenically unsaturated monomer;
   iv. at least one recycled monomer;
   v. optionally at least one carboxyl functional monomer;
   vi. optionally at least one crosslinking functional or multi-ethylenically unsaturated monomer;
b. a second stage in which the polymer of the waterborne polymer composition is obtained by polymerizing:
   i. at least the product obtained in the first stage;
   ii. at least one surfactant;
   iii. at least one ethylenically unsaturated monomer;
   iv. optionally at least one recycled monomer;
   v. optionally at least one crosslinking functional or multi-ethylenically unsaturated monomer;

Wherein said recycled monomer is recycled styrene or its dimer, or its trimer, and comprises from 100 ppm to 25.000 ppm by weight of ethylbenzene.

According to this first aspect, the waterborne polymer composition of the invention may also be preferably obtained by a multistage emulsion polymerization process comprising:
a. a first stage comprising the polymerization of a mixture comprising:
   i. water;
   ii. at least one surfactant;
   iii. at least one ethylenically unsaturated monomer;
   iv. optionally at least one recycled monomer;
   v. optionally at least one carboxyl functional monomer;
   vi. optionally at least one crosslinking functional or multi-ethylenically unsaturated monomer;
b. a second stage in which the polymer of the waterborne polymer composition is obtained by polymerizing:
   i. at least the product obtained in the first stage;
   ii. at least one surfactant;
   iii. at least one recycled monomer;
   iv. optionally at least one crosslinking functional or multi-ethylenically unsaturated monomer;

Wherein said recycled monomer is recycled styrene or its dimer, or its trimer, and comprises from 100 ppm to 25.000 ppm by weight of ethylbenzene.

In a preferred mode of this first aspect, at least one crosslinking functional or multi-ethylenically unsaturated monomer is used in the second stage.

In a preferred mode of this first aspect, at least one recycled styrene, or its dimer, or its trimer, comprising from 100 ppm to 25.000 ppm by weight of ethylbenzene is used in the first stage, and at least one recycled styrene, or its dimer, or its trimer, comprising from 100 ppm to 25.000 ppm by weight of ethylbenzene is used in the second stage.

In this aspect of the invention, at least one ethylenically unsaturated monomer may be advantageously used in the second stage.

These preferred modes may be combined.

The surfactant may be an anionic, non-ionic, cationic, zwitterionic and polymerizable surfactant, especially selected from the group consisting of anionic organic sulfates and sulfonates and non-ionic alkylene oxides, especially ethylene and/or propylene oxides and combinations thereof, preferably selected from the group consisting of organic sulfonates, particularly dodecyl diphenyloxide disulfonates, more particularly sodium dodecyl sulfate, and polymerizable surfactants (surfmers), especially (meth)acrylate, allyl, alkyl, styrenic, maleate, fumarate, crotonate, allyloxy and acrylamide functional groups containing anionic and non-ionic polymerizable surfactants, preferably, ammonium polyoxyalkylene alkenylether sulfates (e.g. Latemul PD-104, Kao Corporation), phosphate esters of polyalkylene monomethacrylates (e.g. Sipomer PAM 200, Solvay), polyoxyethylene styrenated propenyl phenyl ether sulfate ammonium salts (e.g. HITENOL AR series, DKS surfactants), polyoxyethylene-1-(allyloxymethyl) alkyl ether sulfate ammonium salts (e.g. HITENOL KH series, DKS surfactants), polyoxyethylene-1-(allyloxymethyl) alkyl ethers (e.g., NOIGEN KN series, DKS surfactants), polyoxyethylene styrenated propenyl phenyl ethers (e.g., NOIGEN AN series, DKS surfactants).

Appropriate surfactants, could also be anionic surfactants, such as e.g. alkyl, alkyl phenyl or styrenated phenyl sulfates and sulfonates, especially sodium dodecyl sulfate, or polymerizable anionic surfactants containing sulfates and sulfonates together with allyl, propenyl and propenyl phenyl polymerizable groups, or polymerizable non-ionic surfactants with hydrophilic part containing ethylene oxide or propylene oxide groups or mixtures of both together with polymerizable groups like allyl, propenyl and propenyl phenyl.

Suitable cationic surfactants could be benzalkonium chloride, cetylpyridinium chloride, benzethonium chloride, alkyltrimethylammonium salts such as cetyl trimethylammonium bromide and cetyl trimethylammonium chloride, lauryl trimethyl ammonium chloride, C.C.C7-trimethyl ammonium bromides, halide salts of quaternized polyoxyethylalkylamines, dodecylbenzyl tri ethyl ammonium chloride, MIRAPOL® and ALKAQUATR (available from Alkaril Chemical Company) or SANIZOL® (benzalkonium chloride, available from Kao Chemicals),

Suitable zwitterionic surfactants could be cholamidopropyl)dimethylammonio]-1-propanesulfonate) and betaines such as cocamidopropyl betaine have a carboxylate with the ammonium.

The surfactant is preferably used at a concentration from 0.01 to 5% by weight, more preferably from 0.05 to 2.5% by weight, based on the total amount of monomers in said polymer.

The ethylenically unsaturated monomers preferably selected from the same list as previously described for additional monomers in “the polymer” part.

In a second aspect of the invention, the emulsion polymerization is made in the presence of at least one polymeric stabilizer.

When the emulsion polymerization is made with at least one polymeric stabilizer, said polymeric stabilizer is preferably made in the first stage of the process, and said polymeric stabilizer is preferably used in the second stage of the process.

According to this second aspect, the waterborne polymer composition of the invention is preferably obtained by a multistage emulsion polymerization process comprising:
a. a first stage in which a polymeric stabilizer is obtained by polymerizing a mixture comprising:
   i. water;
   ii. at least one carboxyl functional monomer;
   iii. optionally at least one surfactant;
   iv. optionally at least one recycled monomer;
   v. optionally at least one crosslinking functional or multi-ethylenically unsaturated monomer;
b. a second stage in which the polymer of the waterborne polymer composition is obtained by polymerizing:
   i. at least the polymeric stabilizer obtained in the first stage;
   ii. at least one recycled monomer;
   iii. optionally at least one surfactant;
   iv. optionally at least one crosslinking functional or multi-ethylenically unsaturated monomer;

Wherein said recycled monomer is recycled styrene or its dimer, or its trimer, and comprises from 100 ppm to 25.000 ppm by weight of ethylbenzene.

In a preferred mode of this aspect, at least one crosslinking functional or multi-ethylenically unsaturated monomer is used in the second stage.

In a preferred mode of this aspect, at least one surfactant is used in the first stage.

In a preferred mode of this aspect, at least one recycled styrene, or its dimer, or its trimer, comprising from 100 ppm to 25.000 ppm by weight of ethylbenzene is used in the first stage.

In a preferred mode of this aspect, at least one ethylenically unsaturated monomer is used in the first stage and/or in the second stage.

These preferred modes may be combined.

In the first stage, water content is preferably from 50 to 95% by weight, based on the total weight of said first mixture, more preferably from 60% to 80%.

In the first stage, the amount of the at least one carboxyl functional monomer amount is preferably from 1 to 60% by weight, more preferably from 2 to 40% by weight, even more preferably from 5 to 30% by weight, the percentage being based on the total amount of monomer in the first stage.

The carboxyl functional monomer is preferably chosen from the group comprising acrylic acid, methacrylic acid, crotonic acid, maleic acid, itaconic acid, mesaconic acid, fumaric acid, methylenemalonic acid, citraconic acid or mixtures thereof.

In the first stage, the amount of the at least recycled styrene is from 0% to 90%, preferably 10% to 90%, more preferably from 20 to 90%, even more preferably from 40 to 90%, even more preferably from 60 to 90% by weight, the percentage being based on the total amount of monomer in the first stage.

The amount of the at least one crosslinking functional or multi-ethylenically unsaturated monomer is from 0% to 30%, preferably 0.01% to 20%, more preferably from 0.1 to 15%, the percentage being based on the total amount of monomer in the first stage.

The crosslinking functional or multi-ethylenically unsaturated monomer is preferably chosen from the list comprising N-methylol acrylamide, N-methylolmethacrylamide, N-(alkoxymethyl)acrylamides or N-(alkoxymethyl)methacrylamides containing a C1-C6-alkyl radical, e.g. N-isobuthoxymethyl)acrylamide (IBMA), N-(isobutoxymethyl)methacrylamide (IBMMA), N-(n-butoxymethyl)acrylamide (NBMA), N-(n-butoxymethyl)methacrylamide (NBMMA), diacetone acrylamide (DIAAM); multiple ethylenically unsaturated comonomers such as ethylene glycol diacrylate, 1,3-butylene glycol di(meth)acrylate, 1,4-butylene glycol di(meth)acrylate, propylene glycol diacrylate, divinyl adipate, divinyl benzene, vinyl methacrylate, vinyl acrylate, allyl (meth)acrylate, diallyl maleate, diallyl phthalate, diallyl fumarate, methylenebisacrylamide, cyclopentadienyl acrylate or triallyl cyanurate.

The polymerization is preferably made in the presence of a polymerization initiator.

Suitable initiators could be, thermal polymerization initiators, redox polymerization initiators and combinations thereof, particularly inorganic and/or organic persulfates, peroxides, hydroperoxides, perbenzoates, peralkanoates, azoinitiators and combinations thereof, more preferably selected from the group consisting of inorganic and/or organic persulfates, more particularly selected from the group consisting of potassium persulfate (KPS), sodium persulfate (NaPS) and ammonium persulfate (APS).

The initiator system may, for example, be chosen among thermal initiators, redox initiators or combinations thereof, for example tert-butyl hydroperoxide, cumene hydroperoxide, tert-butyl perbenzoate, tert-butyl 2-ethyl perhexanoate, hydrogen peroxide and benzoyl peroxide. Either oil- and/or water-soluble initiators may be used. Suitable reducing agents of a redox initiator system may include compounds, such as sulfur compounds with a low oxidation state, such as sulfites, hydrogen sulfites, alkali metal bisulfites, ketone adducts of bisulfites, such as acetone bisulfite, alkali metal disulfites, metabisulfites and its salts, thiosulfates, formaldehyde sulfoxylates and its salts, reducing nitrogen compounds, such as hydroxylamines, hydroxylamine hydrosulfate and hydroxylammonium salts, polyamines and reducing sugars, such as sorbose, fructose, glucose, lactose and derivatives thereof, enediols, such as ascorbic acid and isoascorbic acid, sulfinic acids, hydroxy alkyl sulfinic acids, such as hydroxy methyl sulfinic acid and 2-hydroxy-2-sulfinactic acid and its salts. Redox initiators are typically used in combination with trace amounts of metal such as iron, for example supplied as ferrous sulfate.

The polymerization is preferably made in the presence of a chain transfer agent. This is particularly advantageous in the first stage.

Suitable chain-transfer agents could be isopropanol, mercaptoethanol, 3-mercaptopropanol, 3-mercaptopropionic acid, 1-butanethiol, 1-propanethiol, 1-prentanethiol, 2-methyl-2-propaneethiol, 1-hexanethiol, 1-octanethiol, tert-nonyl mercaptane, n-dodecyl mercaptane, tert-dodecyl mercaptane, 3-mercapto-3-methyl butanol, 1-mercapto-2-phenyl-2-ethanol, thioglycolic acid, methyl thioglycolate, n-butyl thioglycolate, 2-ethylhexyl thioglycolate, i-octyl thioglycolate, dodecyl thioglycolate, octadecyl thioglycolate, methyl-3-mercaptopropionate, butyl-3-mercaptopropionate, isooctyl-3-mercaptopropionate, isodecyl-3-mercaptopropionate, dodecyl-3-mercaptopropionate, octadecyl-3-mercaptopropionate, 4-methylbenzene thiol, benzenethiol, 4,4′-thiobisbenzenethiol, azelaic alkyl mercaptane, tetrabromomethane and carbon tetrachloride.

The term “polymeric stabilizer (PS)” as used herein and throughout the specification refers to a type of polymeric surfactants which have generally both hydrophobic moieties and carboxylic acid functional groups. They are macromolecules used as surfactants in conventional emulsion polymerization and widely used for producing water-based latexes with improved colloidal properties. This type of an emulsion polymerization process is also referred to as supported emulsion polymerization wherein polymeric stabilizers are the support resins, according to this terminology. The support resins are used in addition to or completely replacing conventional surfactants to colloidally stabilize the growing polymer particles in the emulsion.

When the polymeric stabilizer is obtained from with recycled monomer, the expression “recycled polymeric stabilizer” (RPS) is used.

The polymeric stabilizer has preferably a weight average molecular weight within the range of 1.000 to 120.000 Daltons, preferably within the range of 5.000 to 60.000, more preferably within the range of 10.000 to 50.000, even more preferably within the range of 10.000 to 30.000 Daltons.

The weight average molecular weights of polymeric stabilizers are determined by Gel Permeation Chromatography (GPC). It is for example determined using a device such as Viscotek GPCMax, but not limiting to this specific device and following the exemplified but not limiting method. For the measurement triple-refractive index, light scattering, and viscosity-detectors can be used. In order to dissolve the polymer samples THF as solvent can be used. Molecular weight analysis with GPC instrument are performed with 5 mg/ml solutions of the polymers in Tetrahydrofuran, under a condition of eluent: tetrahydrofuran (TIF) and flow rate: 1.0 mL/min. Two single-pore columns, of which exclusion limits are 400000 Da and 4000000 Da with styrene-divinylbenzene stationary phase, can be used. Polystyrene calibration samples having defined molecular weights can be used for calibration.

The polymeric stabilizer has preferably a solid content between 5 to 40% by weight, preferably between 10 and 30% by weight, more preferably between 25 and 30% by weight.

The solid content of the polymeric stabilizers is determined according to the method of ISO 3251:2019. In said method small aluminum trays (or bigger if necessary) are weighed and recorded as T1. The amount of the substance to be analyzed is weighed into already weighted tray and registered as T2. Same repeated for 3 times. Left the trays in oven at a specified time and temperature which is 20 min. and 150° C. Trays are removed and cooled at room temperature and weighed, registered as T3. Solid content is calculated with the formula below and average of 3 trays is taken:

$$Solid content \% = ( T 3 - T 1 ) / ( T 2 - T 1 ) * 100$$

In the second stage, the waterborne polymer composition is preferably obtained by polymerizing from 2 to 90% by weight of the polymeric stabilizer, preferably from 2 to 65%, more preferably from 40 to 60% by weight.

The expression “from 2 to 90% by weight of the polymeric stabilizer obtained in the first stage” means that the polymeric stabilizer is the product obtained in the first stage.

In the second stage, the amount of the at least recycled styrene is preferably from 1% to 100%, preferably from 2% to 95%, more preferably from 5 to 90%, more preferably from 10 to 90%, more preferably from 20 to 90%, even more preferably from 40 to 90%, even more preferably from 60 to 90% by weight, the percentage being based on the total amount of monomer in the second stage.

In the second stage, the amount of the at least one carboxyl functional monomer amount is preferably from 0.1 to 60% by weight, more preferably from 1 to 40% by weight, even more preferably from 5 to 30% by weight, the percentage being based on the total amount of monomer in the second stage.

The carboxyl functional monomer is preferably chosen from the group comprising acrylic acid, methacrylic acid, crotonic acid, maleic acid, itaconic acid, mesaconic acid, fumaric acid, methylenemalonic acid, citraconic acid or mixtures thereof.

The polymeric stabilizer obtained in the first stage is preferably neutralized with at least one neutralizing agent to a pH value in between the range from 7 to 11. Generally, the resulting neutralized polymeric stabilizer is transparent or semitransparent. In the present invention, the term “semitransparent” means that a solution of the polymeric stabilizer of 2.5% by weight has a value below 35% when measured with light scattering test method.

In the second stage of the multistage emulsion polymerization, the polymerization is preferably made in the presence of a polymerization initiator.

In the second aspect of the invention previously described the polymerization in the first stage and in the second stage are preferably made in the presence of at least one polymerization initiator.

In the two previous aspects of the invention previously described, the flow of the polymerization initiator preferably ends 5 to 15 minutes after the beginning of the polymerization of the first stage and/or of the second stage.

The waterborne polymer composition of the invention can be transformed in solid particles.

This can be done by drying process, for example spraydrying process. The resulting solid particles are for example water-redispersible polymer powder.

### The Process

The present invention also relates to process for producing a waterborne polymer composition by polymerizing at least one recycled monomer, wherein said recycled monomer is recycled styrene or its dimer, or its trimer, and comprises from 100 ppm to 25.000 ppm by weight of ethylbenzene.

The present invention also relates to process for producing a waterborne polymer composition by emulsion polymerization, by polymerizing at least one recycled monomer, wherein said recycled monomer is recycled styrene or its dimer, or its trimer, and comprises from 100 ppm to 25.000 ppm by weight of ethylbenzene.

In the process according to the invention, the recycled styrene or its dimer, or its trimer, comprises from 100 ppm to 25.000 ppm by weight of ethylbenzene, and may also preferably comprises at least one other impurity form the following list: cumene, xylene (ortho, meta, para), toluene, benzene, 2,4,6-triphenyl-1-hexene, 2,4-diphenyl-1-butene, vinyl toluene, 1,3-diphenylpropane, alpha-methyl styrene, the amount of said impurity being selected from the respecify ranges described above.

In the process according to the invention, the recycled styrene or its dimer, or its trimer is preferably substantially not purified during the recycling process.

The present invention relates to process for producing a waterborne polymer composition by:
providing a polymer comprising styrene monomer unit;
recycling said polymer in a recycling process to obtain recycled styrene or its dimer, or its trimer that comprises from 100 ppm to 25.000 ppm by weight of ethylbenzene;
polymerizing said at least one recycled styrene obtained in said recycling process;
wherein the recycling styrene is substantially not purified during the recycling process.

In the process according to the invention, the recycled styrene or its dimer, or its trimer is preferably obtained by a recycled process that does not comprise a purification step.

The present invention relates to process for producing a waterborne polymer composition by:
providing a polymer comprising styrene monomer unit;
recycling said polymer in a recycling process to obtain recycled styrene or its dimer, or its trimer that comprises from 100 ppm to 25.000 ppm by weight of ethylbenzene;
polymerizing said at least one recycled styrene obtained in said recycling process;
wherein the recycling process does not comprise a purification step.

The present invention also relates to process for producing a waterborne polymer composition by emulsion polymerization, said process comprising:
a. Preparing a mixture comprising at least one surfactant and/or at least one polymeric stabilizer, and at least one recycled monomer, wherein said recycled monomer is recycled styrene or its dimer, or its trimer, and comprises from 100 ppm to 25.000 ppm by weight of ethylbenzene;
b. Initiating the polymerization;
c. Obtaining a polymer emulsion.

In the process according to the invention, the same monomers as described in “the polymer” part may be used, at the same amount.

The present invention relates to a multistage emulsion polymerization process for producing a waterborne polymer composition, said process comprising the following successive steps:
a. Forming a first mixture comprising:
   i. water;
   ii. at least one surfactant;
   iii. at least one ethylenically unsaturated monomer;
   iv. at least one recycled monomer;
   v. optionally at least one carboxyl functional monomer;
   vi. optionally at least one crosslinking functional or multi-ethylenically unsaturated monomer;
b. Polymerizing said first mixture in the presence of at least one polymerization initiator;
c. Forming a second mixture comprising:
   i. at least the product obtained in the step b;
   ii. at least one surfactant;
   iii. at least one ethylenically unsaturated monomer;
   iv. optionally at least one recycled monomer;
   v. optionally at least one crosslinking functional or multi-ethylenically unsaturated monomer;
d. Polymerizing said second mixture in the presence of at least one polymerization initiator to obtain the waterborne polymer composition;
   wherein said recycled monomer is recycled styrene or its dimer, or its trimer, and comprises from 100 ppm to 25.000 ppm by weight of ethylbenzene.

The present invention also relates to a multistage emulsion polymerization process for producing a waterborne polymer composition, said process comprising the following successive steps:
a. Forming a first mixture comprising:
   i. water;
   ii. at least one surfactant;
   iii. at least one ethylenically unsaturated monomer;
   iv. optionally at least one recycled monomer;
   v. optionally at least one carboxyl functional monomer;
   vi. optionally at least one crosslinking functional or multi-ethylenically unsaturated monomer;
b. Polymerizing said first mixture in the presence of at least one polymerization initiator;
c. Forming a second mixture comprising:
   i. at least the product obtained in step b;
   ii. at least one surfactant;
   iii. at least one recycled monomer;
   iv. optionally at least one crosslinking functional or multi-ethylenically unsaturated monomer;
d. Polymerizing said second mixture in the presence of at least one polymerization initiator to obtain the waterborne polymer composition;
   wherein said recycled monomer is recycled styrene or its dimer, or its trimer, and comprises from 100 ppm to 25.000 ppm by weight of ethylbenzene.

The present invention also relates to a multistage emulsion polymerization process for producing a waterborne polymer composition, said process comprising the following successive steps:
a. Forming a first mixture comprising:
   i. water;
   ii. at least one carboxyl functional monomer;
   iii. optionally at least one surfactant;
   iv. optionally at least one recycled monomer;
   v. optionally at least one crosslinking functional or multi-ethylenically unsaturated monomer;
b. Polymerizing said first mixture in the presence of at least one polymerization initiator, to produce a polymeric stabilizer;
c. Neutralizing the polymeric stabilizer with at least one neutralizing agent to a pH value in between the range from 7 to 11;
d. Forming a second mixture comprising:
   i. at least the neutralized polymeric stabilizer obtained in step c;
   ii. at least one recycled monomer;
   iii. optionally at least one surfactant;
   iv. optionally at least one crosslinking functional or multi-ethylenically unsaturated monomer;
e. Polymerizing said second mixture in the presence of at least one polymerization initiator to obtain the waterborne polymer composition;
   wherein said recycled monomer is recycled styrene or its dimer, or its trimer, and comprises from 100 ppm to 25.000 ppm by weight of ethylbenzene.

In the process described above, the flow of the polymerization initiator preferably ends 5 to 15 minutes after the beginning of the polymerization of step b and/or e.

The resulting polymer comprises from 1 to 100% by weight of at least one recycled monomer based on the total amount of monomers in said polymer. The same preferred ranges of recycled monomer amount as described above apply.

The first mixture of step a comprises water, preferably from 50 to 95% by weight of water, based on the total weight of said first mixture, more preferably from 60% to 80%.

The polymeric stabilizer obtained at step b has preferably a solid content from 5 to 40% by weight, preferably between 10 and 30% by weight, more preferably between 25 and 30% by weight.

### Use of the Waterborne Polymer Composition

The present invention relates to the use of the waterborne polymer composition according to the invention, or the waterborne polymer composition resulting from process of the invention, to produce coating, paint, primer, ink, varnish, pressure sensitive adhesive, water proofing membrane, sealant, roof coating, redispersible powder, external thermal insulation composite system, tile adhesive, tile grout, repair mortar, self levelling mortar, additive for paper application, paper coating, paper sizing agents, and use of said waterborne polymer composition as textile polymers in finishing, in coating, in adhesive, in flocking, or in nonwoven, or as textile auxiliaries in pretreatment, in dyeing, in printing, or in finishing, or as leather additive in wet end or in finishing, or as additive in construction, or as paper additive.

The waterborne polymer composition used is preferably an emulsion. The quantity of the waterborne polymer composition of the invention used to produce above final product and in the above applications is comprised between 0.1 to 75% by weight.

The present invention also relates to a coating, paint, primer, ink, pressure sensitive adhesive, or varnish made with the waterborne polymer composition according to the invention or the waterborne polymer composition resulting from process of the invention.

The minimum film forming temperature of the waterborne polymer composition is between −50° C. and +50° C., preferably between −30° C. and +30° C.

The waterborne polymer composition of the invention may be advantageously used in coating formulations such as interior or exterior paints, primers, plasters, trowel applied decorative coatings for architectural applications, also for industrial wood and metal coatings, coatings for plastic & composite surfaces, road marking paints, roof coatings, roof tile paints, seed coating, floor coatings, printings inks and overprint varnishes, pressure sensitive adhesives such as paper label adhesive, packaging tape adhesive, protective film adhesive, lamination adhesive, contact adhesive, paper tape adhesive, masking tape adhesive, film label adhesive, cold seal-heatseal adhesive, flooring adhesive, flexible packaging adhesive, tapes, protective films, packaging lamination, specialty paper, paper coating, paper impregnation binder, release binder, paper saturation binder etc., textile and leather applications such as finishing, coating, flocking, nonwoven, printing, wet end, finishing and construction applications such as waterproofing & sealing, cement modifiers, sealants, tile adhesives, dust and soil stabilization coatings, concrete ad-mixtures, and grouts, self-leveling compounds and redispersible powders.

The invention and the advantages thereof will become more apparent from the following examples.

### EXAMPLES

### A) Synthesis of Polymer Emulsion

In the following polymer emulsion synthesis, the surfactant A and B below are used.

Surfactant A (solids: 28%), available from Solvay, is sodium C12-14 lauryl sulphate.

Surfactant B (solids: 100%), available from Sasol, is a fatty alcohol polyethyleneglycol ether, based on MARLIPAL 13 and ethylene oxide (about 12 moles).

In the following polymer emulsion synthesis, a virgin styrene monomer and a recycled styrene monomer are used. Table 1 discloses the characteristics of said monomers.

TABLE 1
Impurities levels in virgin styrene and in recycled styrene

| Impurities | virgin styrene | recycled styrene |
|---|---|---|
| Ethyl benzene | 78 | 1935 |
| Cumene | 107 | 835 |
| Xylene (ortho, meta, para) | 331 | 1452 |
| Toluene | <1 ppm | 91 |
| Benzene | <1 ppm | 79 |
| 2,4,6-triphenyl-1-hexene | <1 ppm | 169 |
| 2,4-diphenyl-1-butene | <1 ppm | 271 |
| Vinyl toluene | 35 | 215 |
| 1,3-diphenylpropane | <1 ppm | 293 |
| Alpha-methyl styrene | 168 | 9575 |

### Example 1: Comparative Trial 1: Styrene Acrylic Polymer Emulsion (EM1) by Using the Virgin Styrene Monomer

To a 3-necked flask equipped with stirrer, thermometer, and a reflux condenser, 214.3 parts of deionized water, 2 parts of Surfactant A and 4 parts of Surfactant B were added respectively. Thereupon the flask was heated to 85° C. 1.3 parts of sodium persulphate dissolved in 7.58 parts of deionized water was added into the flask.

Afterwards, 32.6 parts of pre-emulsion was taken from the emulsion, consisting of 77.1 parts of deionized water, 22.1 parts of Surfactant A, 30 parts of Surfactant B, 227.17 parts of styrene, 1.5 parts of acrylic acid, and 232.86 parts of butyl acrylate, and later was added into the flask. Remaining part of the emulsion and 2.5 parts of sodium persulphate dissolved in 58.3 parts of deionized water were fed at 78° C. in 2 hrs.

At the end of feeding, the temperature was risen to 90° C. and the reaction mixture was kept at this temperature for 5 minutes. First neutralization was performed at 90° C. by adding 2.76 parts of 25% ammonium hydroxide solution and pH was adjusted to between 5.0-6.0. Subsequently, the flask was cooled down to 65° C. and 1.06 parts of tert-butyl hydroperoxide dissolved in 10 parts of deionized water was added into the flask in 10 minutes.

After 15 minutes of waiting time, 0.5 parts of sodium metabisulphite dissolved in 11.72 parts of deionized water was added into the flask in 10 minutes. After these steps, the flask was cooled down to 40° C. and 2.41 parts of 25% ammonium hydroxide solution was added at the same temperature in order to adjust the flask pH between 7.5-9.0. At 30° C. biocides were added. At the end of the reaction, 104.3 parts of deonized water was added.

The polymer emulsion of Comparative trial 1 (EM1) has the following characteristics: Solid content: 50.1%, Viscosity (Brookfield RVT 5/20): 2360 cps, pH: 8.5, particle size: 129 nm.

### Example 2: Inventive Trial 1: Styrene Acrylic Polymer Emulsion (EM2) by Using the Recycled Styrene Monomer

Inventive trial 1 is prepared according to the same procedure as described in the Comparative trial 1, except that instead of the virgin styrene monomer, the recycled styrene monomer is used.

The polymer emulsion of Inventive trial 1 (EM2) has the following characteristics: Solid content: 50.1%, Viscosity (Brookfield RVT 5/20): 2300 cps, pH: 8.5, particle size: 130 nm.

### Example 3: Comparative Trial 2: Styrene Acrylic Multistage Emulsion Polymer (EM3) by Using the Virgin Styrene Monomer

Firstly, a monomer emulsion 1 (E-1) was prepared by mixing 108.31 parts of deionized water, 9.16 part of Surfactant A, 6.15 parts of allyl methacrylate, 8.99 parts of methacrylic acid, 60 parts of styrene, 157.21 parts of butyl acrylate. A monomer emulsion 2 (E-2) was prepared by mixing 84.85 parts of deionized water, 7.76 parts of surfactant A, 1.77 parts of allyl methacrylate, 2.62 parts of methacrylic acid, 117.21 parts of methyl methacrylate, 25 parts of styrene, 35.34 parts of butyl acrylate.

Secondly, 246.12 parts of deionized water and 11.33 parts of Surfactant A were added respectively to a 3-necked flask equipped with stirrer, thermometer, and a reflux condenser. Thereupon the flask was heated to 81° C. 26.17 parts of pre-emulsion taken from E-1 was added into the flask.

Subsequently, 0.19 parts of sodium persulfate dissolved in 4.80 parts of deionized water was added into the flask. Remaining part of E-1 and 1.19 parts of sodium persulfate dissolved in 33.20 parts of deionized water were fed at 81° C., and feeding times were 80 min and 160 min for E-1 and sodium persulfate solution, respectively. E-1 feed was completed by purging with 3.84 parts of deionized water.

After completing the feed of remaining E-1, E-2 was added into the flask over 80 min. The temperature of the reaction mixture was increased to 85° C. 15 min before the end of the catalyst solution feeding. E-2 feed was completed by purging with 7.68 parts of deionized water. Thereupon the completion of feedings the reaction mixture was kept at this temperature for 30 minutes.

After this step, the reaction flask was cooled down to 70° C. First neutralization was performed at 70° C. by adding 1.92 parts of 28% ammonium hydroxide solution dissolved in 3.84 parts of deionized water. 0.50 parts of tert-butyl hydroperoxide dissolved in 6.92 parts of deionized water was added into the flask in 10 minutes. After 10 minutes of waiting time, 0.38 parts of Bruggolite® FF6 M dissolved in 6.99 parts of deionized water was added into the flask in 10 minutes. After these steps, the flask was cooled down to 50° C. and 0.96 parts of 28% ammonium hydroxide solution dissolved in 2.88 parts of deionized water was added at the same temperature in order to adjust the flask pH between 8.0-8.5. At 30° C. biocides were added.

The polymer emulsion of Comparative trial 2 (EM3) has the following characteristics: Solid content: 42.8%, Viscosity (Brookfield LVT 2/60): 155 cps, pH: 8.1, particle size: 73 nm.

### Example 4: Inventive Trial 2: Styrene Acrylic Multistage Emulsion Polymer (EM4) by Using the Recycled Styrene Monomer

Inventive trial 2 was prepared according to the same procedure as described in the Comparative trial 2, except that instead of the virgin styrene monomer, the recycled styrene monomer is used.

The polymer emulsion of Inventive trial 2 (EM4) has the following characteristics: Solid content: 42.9%, Viscosity (LVT 2/60): 147 cps, pH: 8.2, particle size: 74 nm.

### B) Test Results

The polymer emulsions EM1 to EM4 obtained in part A) have been tested in paint and varnish. For a better understanding of the test plan, table 2 recapitulates the correspondences between Examples, polymer emulsion and paints and varnishes.

TABLE 2
Description of examples, polymer emulsions, paints and varnishes.

| | | Styrene | Polymer | |
|---|---|---|---|---|
| Example | Trial | monomer | emulsion | Paint/Varnish |
| Ex1 | Comparative 1 | Virgin | EM1 | PVC paint 1 |
| Ex2 | Inventive 1 | Recycled | EM2 | PVC paint 2 |
| Ex3 | Comparative 2 | Virgin | EM3 | Varnish 1 |
| Ex4 | Inventive 2 | Recycled | EM4 | Varnish 2 |

These Paints and varnishes are tested with the following application tests.

### pH Measurements

To measure pH effectively (according to ISO 976), a pH meter is used (Schott LAB 850 type). Paint sample is put on a clean glass beaker for measurement. The pH meter is calibrated according to instructions. Sample to be measured should be well-mixed and homogeneous. The probe of pH meter is immersed into the paint sample for the specified time and pH is measured.

### Viscosity Measurements

Brookfield and Krebs Stormer viscometers are commonly used to measure viscosity, at a specific temperature, under defined shear conditions.

Brookfield viscometer gauges the torque needed to rotate a spindle in a fluid. By altering speeds and spindles, a range of viscosities can be measured. Viscosity of paint can be measured by a Brookfield viscometer at 25° C. as cP (centipoises).

Krebs viscometer is also utilized to measure the viscosity of paints according to ASTM D562. The Krebs Stormer viscometer indeed stands as a standard tool in the paint industry for assessing viscosity, providing a convenient means to measure resistance in paint at a rotation speed. The resistance created by the paint is measured and expressed in Krebs units, or Kus. The higher the KU number, the more viscous is the paint. This method is especially beneficial for ensuring consistency in paint production and exploring new coating formulations. Approximately, 300 g of paint at 25° C. in a container is used for measurements.

### Gloss Measurements

Gloss measurements of paint samples are measured by glossmeters on 100 micron (wft) paint films. Measurements are done after 1 day, 3 days and 7 days accordingly to see the gloss development of the coating. The glossmeter is placed perpendicular to the painted surface at a specified angle (commonly 20°, 60°, or 85°). The instrument emits a light beam onto the surface and the amount of reflected light is measured.

### Dry Opacity

The test was done according to BS EN ISO 6504-3. The paints were applied to black-white opacity card to achieve a wet film thickness of 200 microns. The film width should be at least 70 mm. Paint films should be cured at least for 16 hours at (23±2°) C temperature and (50±5)% relative humidity. After 7 days of curing, opacity was measured using a spectrophotometer. The results were reported as percentage.

### Tinting Strength

It is a method used to measure the coloring capacity of a paint or pigment when mixed with a specific quantity of white paint. Typically, this test involves mixing the sample pigment with a white paint at predetermined ratios to assess the degree of color change. Tinting strength of the paint is measured according to the internal method as explained hereinbelow.

During the test, 2% Pigment Violet 23 is mixed with paint samples (both standard reference and new experiments). Samples thoroughly mixed in their containers and their coloration are compared against a non-absorbent card. As a comparison measurement, a reference or standard from another product is drawn alongside, ensuring a 100-micron wet film thickness (WFT). Once the films are fully dried, color values of L, a, b are measured on paint films using an X-Rite spectrophotometer for analysis. Lower tinting strength indicates that the samples are exhibiting a darker hue, while higher tinting strength indicates a lighter appearance.

### Hardness

Hardness of the coating films were measured using Persoz or Konig Pendulum. 150 μm WFT (wet film thickness) applied on glass panel and left to be dried at 23° C. temperature and 50% relative humidity. Hardness test was done in accordance with EN ISO 1522:2006. The procedure as per Persoz is, based on the measurement of the damping of a pendulum oscillating on the paint film.

### Blocking Resistance

200 μm wet film thickness applied on PVC sheets, dried for 30 minutes at 40° C.; then two pieces closed face-to-face and blocked under 2 kg for 24 hours at 23° C. After that, test pieces were separated from each other and blocking resistance were checked as mentioned in ASTM-D 4946 based on numerical rating code as 1 to 10. (10: best; 1: worst).

Blocking resistance is a measure of a coating's ability to resist destructive self-adhesion when placed into contact with itself. This is an important feature for coatings, especially for industrial paints rather than decorative ones. In this application test, components are generally dried in ovens and stacked. During this stacking procedure, the painted surfaces are placed in contact and they apply a certain pressure to each other. Due to this pressure, the materials either stick together or are easily separated without sticking, depending on the blocking resistance of the surface. The material with good blocking resistance can be separated without any damage.

### Stain Resistance

A test paint was applied on Leneta P-121-10N black vinyl charts with wet film thickness of 200 micron. The coating films were allowed to dry for 7 days at 23° C. and 50% relative humidity conditions. Different stains were then applied on the cured film for different time periods (5 min and 1 h). After a specified contact time, the film was cleaned with a piece of napkin. Subsequently, the film was washed with 3M commercial sponge saturated with liquid soap. After washing, the residual soap solution was gently rinsed off and the panels were allowed to dry. ΔE color differences between the staining of the coating and the reference unstained surface were measured with X-Rite Ci60 spectrophotometer in accordance with ASTM D 2244. By definition, smaller ΔE values indicate better stain resistance, since they indicate that the stained and the reference surfaces are more alike in terms of color.

### Adhesion on Fiber Cement/Pine/Metal-Cross-Cut Dry Adhesion Test

The level of dry adhesion to specific test panels was determined using a cross-cut test in accordance with DIN EN ISO 2409. A test paint was applied on specific test panels (fiber cement, pine, stainless metal). Wet film thickness was 100 microns for non-porous substrates and 200 micron for porous substrates. The coated panels were allowed to dry for 7 days at 23° C., 50% relative humidity conditions. A cross-cut was made onto the dried coated panels using a cross-cut knife (Byk-5122). A self-adhesive tape (TESA 4204) was applied under uniform pressure onto the coated substrate, covering the cross-cut, where after the tape was pulled off in a single movement. The degree of dry adhesion of the coating onto the particular substrate was then classified with a scale of from 0 to 5 (according ISO Class 0-5) by determining the amount of coating that is detached or flaked partly or wholly along the edges of the cuts, where 0 means that the cross-cut area is not affected (excellent adhesion); 1 means that the affected cross-cut area is not significantly greater than 5%; 2 means that the affected cross-cut area is significantly greater than 5%, but not significantly greater than 15%; 3 means that the affected cross-cut area is significantly greater than 15%, but not significantly greater than 35%; 4 means that the affected cross-cut area is significantly greater than 35%, but not significantly greater than 65%; 5 means any degree of flaking that cannot even be classified by classification 4 (very poor adhesion).

### Adhesion on Fiber Cement/Pine/Metal-Cross-Cut Wet Adhesion Test

To determine the level of wet adhesion on test panel, a cross-cut was made onto the dried coated panels (fiber cement, pine and stainless metal) using a cross-cut knife (Byk-5122). A napkin was placed onto coated and cross-cut substrate. Subsequently, the napkin was saturated with water and contacted with the substrate for 30 min. After a specified contact time, wet napkin was removed and the panel was allowed to dry. A self-adhesive tape was applied under uniform pressure onto the coated substrate, covering the cross-cut, where after the tape was pulled off in a single movement. The level of wet adhesion was then determined according the cross-cut test method.

### Wet Scrub Resistance

According to ISO 11998, wet scrub resistance refers to a dry coating's capability to exhibit minimal thickness loss, calculated as an average over a specific area, after 200 wet scrubbing cycles. This method not only assesses scrub resistance but also evaluates cleanability, which defines a coating's ability to withstand soil penetration and release during cleaning without exceeding a specified reduction in thickness.

The methodology involves subjecting the coating to standardized temperature and humidity conditions before initiating the scrubbing process and conducting operations to determine the density of the dry coating. The scrubbing process, as per ISO 11998, entails 200 cycles using a standardized non-woven pad attached to a handle. However, EN 13300 (European classification) dictates that scrubbing with lower quality paints should involve only 40 cycles.

Cleanability assessment follows the same conditions as wet scrub resistance testing, except that it involves the removal of staining agents (soilants). The nature and application method of these soilants are determined by the user conducting the test.

Paints were applied on Leneta P-121-10N black vinyl charts with wet film thickness of 200 micron. After 7 days drying period at 23° C. and 50% relative humidity conditions, test was carried out with a wet scrub resistance tester. After 200 cycles, abrasion was calculated in microns and classification is done according to EN 13300.

The European classification EN 13300, for interior wall and ceiling paints defines a number of parameters divided into different classes. One of them is wet scrub resistance. It classifies 5 classes differing in increasing loss of coating thickness after scrubbing according to ISO 11998. The requirements for each class are presented on the table 3 below.

TABLE 3
ISO 11998 requirements

| EN 13300 class | Requirements |
|---|---|
| 1 | <5 μm after 200 cycles |
| 2 | ≥5 μm and <20 μm after 200 cycles |
| 3 | ≥20 μm and <70 μm after 200 cycles |
| 4 | <70 μm after 40 cycles |
| 5 | ≥70 μm after 40 cycles |

### Storage Stability

Storage stability test was done to ensure if the paint remains usable and effective throughout its shelf life or not and also to assess how the paint will perform when used after a prolonged storage period. Test was done with an internal method. 250 g wet paint samples were put in a glass container and checked in terms of odour, initial viscosity, pH and gloss. Then they put in an oven at 50° C. for 7 days. After 7 days drying in oven, the samples were cooled down to room temperature, observations were done and noted such as separation, sedimentation, changes in viscosity, color, odour, or any other physical or chemical alterations. Various tests were performed on the stored samples, such as viscosity checks and pH measurement. These tests helped determining if the paint's characteristics meet the specified standards even after storage.

### Chemical Resistance

Chemical resistance tests are designed to assess how coatings withstand, when exposure to different test liquids. These tests typically involve spot tests. They aim to ascertain the impact of various chemicals on coatings, looking for signs of discoloration, loss of adhesion, or any other paint defects caused by the exposure to these chemicals. In these evaluations, coatings are subjected to different chemicals by applying the chemicals directly to localized areas (spot tests). The purpose is to mimic real-world scenarios where the coating might come into contact with these substances.

Spot tests involve applying small quantities of different test liquids onto the coating surface and observing the immediate reactions. This method helps determining how quickly and severely the coating might react to particular substances.

During these tests, observations were done to see changes in the coating's appearance, such as color alteration, loss of gloss, blistering, cracking, or any visible signs of deterioration.

By conducting these chemical resistance tests. 200 microns (wft) paint films were applied on lenata subsrates after 7 days drying at 23° C. and 50% relative humidity conditions, tests were carried out with different chemicals (water, ethanol, ammonia solution and etc.) at a specific time according to chemicals. Afterwards, the surface was cleaned with a soft sponge, and the area was examined after drying.

The rating for chemical resistance was done according to DIN 68861, below:
5: No visible changes
4: Minor change in gloss or colour only from one viewing angle
3: Slight change in gloss or colour; visible in several viewing directions; the structure is still generally unchanged
2: Severe marking visible; the structure of the test surface is still generally unchanged
1: Severe marking visible; the structure of the test surface is changed
0: Test surface severely changed or destroyed.
   PVC Paint Made with Polymer Emulsion of Comparative1 Trial (EM1) and Inventive1 Trial (EM2).

A PVC paint formulation (2400 solids) (PVC paint 1) is produced with polymer emulsion EM1 (Comparative trial 1), and a PVC paint formulation (24% solids) (PVC paint 2) is produced with polymer emulsion EM2 (Inventive trial 1). The PVC paint formulation is described in Table 4.

TABLE 4
PVC paint formulation

| Component | Amount (weight %) |
|---|---|
| Water | 10 |
| HEC thickener | 0.3 |
| Neutralizing agent | 0.1 |
| Dispersing Agent | 0.5 |
| Wetting agent | 0.6 |
| Defoamer | 0.3 |
| Open time extender | 1 |
| TiO2 | 16 |
| Extender | 4 |
| Extender 2 | 7 |
| Polymer emulsion | 55 |
| PU Thickener | 0.3 |
| Coalescing agent | 2 |
| Water | 2.8 |
| Defoamer | 0.1 |
| TOTAL | 100 |

The test results obtained on PVC paint 1 and PVC paint 2 are recapitulates in Table 5 below.

TABLE 5
Tests results on PVC paint 1 (Comparative)
and PVC paint 2 (Inventive)

| | PVC paint 1 | PVC paint 2 |
|---|---|---|
| | (Comparative) | (Inventive) |
| pH | 8.7 | 8.7 |
| Initial Krebs | 100 | 100 |
| Overnight Krebs | 112 | 114 |
| Hardness Koenig | 15.4/18.3/25.2 | 16.8/21/28 |
| (1 d-4 d-7 d) | | |
| ISO SCRUB | 1.35 | 0.85 |
| (micron - g/m²) | | |
| (lower is better) | | |
| Gloss (20°-60°-85°) | 3.3/20.2/44.1 | 3.5/21.0/57 |
| Color strength with | 51.53/18.20/−35.20 | 51.39/18.29/−35.27 |
| PV23 pigment (2%) | | Delta E: 0.18 |
| Opacity (%) | 0.98 | 0.98 |

Stain Resistance (Delta E values)

| | | |
|---|---|---|
| Tea 5 min | 3.4 | 3.0 |
| Tea 1 h | 8.9 | 8.4 |
| Coffee 5 min | 3.65 | 3.20 |
| Coffee 1 h | 8.35 | 8.1 |
| Red Wine 5 min | 1.65 | 1.36 |
| Red Wine 1 h | 4.30 | 4 |
| Mustard 5 min | 2.4 | 2.2 |
| Mustard 1 h | 8.34 | 8.2 |
| Ketchup 5 min | 0.3 | 0.28 |
| Ketchup 1 h | 1.03 | 1 |
| Chocolate Sauce 5 min | 0.15 | 0.05 |
| Chocolate Sauce 1 h | 0.52 | 0.35 |
| Marker 5 min | 0.07 | 0.07 |
| Marker 1 h | 0.78 | 0.65 |
| Blue Crayon 5 min | 0.49 | 0.5 |
| Blue Crayon 1 h | 0.34 | 0.3 |
| Total | 44.67 | 41.66 |

According to the test results, the polymer emulsion made with the recycled styrene monomer (Inventive1, EM2) gives significant better results than the polymer emulsion made with the virgin styrene monomer (Comparative1, EM1).

PVC paint 2 (Inventive) exhibits better hardness when compared to PVC paint 1 (Comparative1).

PVC paint 2 (Inventive) displays better wet scrub resistance when compared to PVC paint 1 (Comparative1).

PVC paint 2 (Inventive) shows better stain resistance when compared to PVC paint 1 (Comparative1). Particularly notable improvements were observed in resisting tea, coffee, red wine and chocolate sauce (the lower the better).

Opacity performances are similar for both products.

These results demonstrate that, despite the presence of a high level of ethylbenzene in the recycled styrene monomer, approximatively 25 times the level of ethylbenzene in the virgin styrene monomer, the overall performances of PVC paint made with the recycled styrene monomer are better compared to the performances of PVC paint made with the virgin styrene monomer.

These results demonstrate that, despite the presence of a high level of cumene in the recycled styrene monomer, approximatively 8 times the level of cumene in the virgin styrene monomer, the overall performances of PVC paint made with the recycled styrene monomer are better compared to the performances of PVC paint made with the virgin styrene monomer.

The same is demonstrate for the other impurities, and the results demonstrate that, despite the presence of a high level of impurities in the recycled styrene monomer, compare to the low level of impurities in the virgin styrene monomer, the overall performances of PVC paint made with the recycled styrene monomer are better compared to the performances of PVC paint made with the virgin styrene monomer.

Varnish Made with Polymer Emulsion of Comparative2 Trial (EM3) and Inventive2 Trial (EM4).

A varnish formulation (24% solids) (Varnish 1) is produced with polymer emulsion EM3 (Comparative trial2), and a varnish formulation (24% solids) (Varnish 2) is produced with polymer emulsion EM4 (Inventive trial2). The varnish formulation is described in Table 6.

TABLE 6
Varnish formulation

| Component | Amount (weight %) |
|---|---|
| Polymer emulsion | 67.3 |
| Water | 20.0 |
| Coalescing agent | 2.7 |
| Defoamer | 1.0 |
| Surface Wetting Agent | 0.1 |
| Defoamer | 0.3 |
| PU thickener | 1.6 |
| Water | 7.0 |
| Total | 100.0 |

The test results obtained on Varnish 1 and Varnish 2 are recapitulates in Table 7 below.

TABLE 7
Tests results on Varnish 1 (Comparative) and Varnish 2 (Inventive)

| | Varnish 1 | Varnish 2 |
|---|---|---|
| | (Comparative) | (Inventive) |
| pH | 8 | 8.2 |
| pH after (storage stability) | 7.45 | 7.72 |
| Initial Krebs viscosity | 90 | 91 |
| Krebs viscosity (Overnight) | 92 | 93 |
| Krebs (after storage stability) | 88 | 86 |
| Brookfield viscosity initial | 3.500-3.260-2.640 | 3.750-3.440-2.730 |
| sp6 (20/50/100) | | |
| Brookfield viscosity (after | 2.200-2.080-1.810 | 1.700-1.620-1.460 |
| storage stability) | | |
| sp6 (rpm 20/50/100) | | |
| Hardness Koenig | 32.2-36.4-39.1 | 35.4-39.8-43 |
| (1 d-3 d-6 d) | | |
| Gloss (20°-60°-85°) | 143-137-109 | 145-143-113 |
| Adhesion on pine | 0/0 | 0/0 |
| (wet/dry) | | |
| Blocking Resistance (23° C.) | 8/8 | 9/9 |
| Blocking Resistance (50° C.) | 8/8 | 9/9 |

Chemical Resistance

| | | |
|---|---|---|
| Ammonia (2 min) | 5 | 5 |
| Ethanol (1 h) | 4 | 4 |
| Coffee (1 h) | 5 | 5 |
| Water (1 h) | 4 | 4 |

The results show that, both Varnish formulation 1 (Comparative) and 2 (Inventive) exhibited similar pH and viscosity values. Upon examining viscosity changes after storage stability, similar results are obtained in terms of Krebs and Brookfield viscosity.

According to the test results, the polymer emulsion made with the recycled styrene monomer (Inventive2, EM4) gives significant better results than the polymer emulsion made with the virgin styrene monomer (Comparative2, EM3).

Varnish 2 (Inventive) exhibits better hardness when compared to Varnish 1 (Comparative).

Varnish 2 (Inventive) displays superior gloss value when compared to Varnish 1 (Comparative).

Varnish 2 (Inventive) shows superior blocking resistance when compared to Varnish 1 (Comparative1).

Adhesion on pine and chemical resistances performances are similar for both products.

These results demonstrate that, despite the presence of a high level of ethylbenzene in the recycled styrene monomer, approximatively 25 times the level of ethylbenzene in the virgin styrene monomer, the overall performances of Varnish made with the recycled styrene monomer are better compared to the performances of Varnish made with the virgin styrene monomer.

These results demonstrate that, despite the presence of a high level of cumene in the recycled styrene monomer, approximatively 8 times the level of cumene in the virgin styrene monomer, the overall performances of Varnish made with the recycled styrene monomer are better compared to the performances of Varnish made with the virgin styrene monomer.

The same is demonstrate for the other impurities, and the results demonstrate that, despite the presence of a high level of impurities in the recycled styrene monomer, compare to the low level of impurities in the virgin styrene monomer, the overall performances of Varnish made with the recycled styrene monomer are better compared to the performances of Varnish made with the virgin styrene monomer.

1. A waterborne polymer composition, comprising a polymer obtained from 1 to 100% by weight of at least one recycled monomer, wherein said recycled monomer is recycled styrene, or its dimer, or its trimer, and comprises from 100 ppm to 25.000 ppm by weight of ethylbenzene.

2. The waterborne polymer composition according to claim 1, wherein the recycled monomer comprises from 150 ppm to 25.000 ppm by weight of cumene.

3. The waterborne polymer composition according to claim 1, wherein the recycled monomer comprises from 400 ppm to 15.000 ppm by weight of xylene (ortho, meta, para).

4. The waterborne polymer composition according to claim 1, wherein the recycled monomer comprises from 10 ppm to 3.000 ppm by weight of toluene.

5. The waterborne polymer composition according to claim 1, wherein the recycled monomer comprises from 10 ppm to 3.000 ppm by weight of benzene.

6. The waterborne polymer composition according to claim 1, wherein the recycled monomer comprises from 1 ppm to 5.000 ppm by weight of 2,4,6-triphenyl-1-hexene.

7. The waterborne polymer composition according to claim 1, wherein said waterborne polymer composition comprises from 50 ppm to 18.800 ppm of ethylbenzene.

8. The waterborne polymer composition according to claim 7, wherein said ethylbenzene present in the waterborne polymer composition comes or derived from the recycled styrene used to make said waterborne polymer composition.

9. The waterborne polymer composition according to claim 1, wherein the polymer is obtained:
from 1 to 99.9% by weight of at least one recycled monomer;
from 0.1 to 50% by weight of at least one additional monomer;
optionally from 0.1 to 50% by weight of at least one biobased monomer.

10. A process for producing a waterborne polymer composition by polymerizing at least one recycled monomer, wherein said recycled monomer is recycled styrene or its dimer, or its trimer, and comprises from 100 ppm to 25.000 ppm by weight of ethylbenzene.

11. The process according to claim 8, wherein the polymerization is made by emulsion polymerization, said process comprising:
a. preparing a mixture comprising at least one surfactant and/or at least one polymeric stabilizer, and/or at least one stabilizing agent, and at least one recycled monomer, wherein said recycled monomer is recycled styrene or its dimer, or its trimer, and comprises from 100 ppm to 25.000 ppm by weight of ethylbenzene;
b. initialing the polymerization; and
c. obtaining a polymer emulsion.

12. The process according to claim 11, wherein the polymerization is made by multistage emulsion polymerization, said process comprising the following successive steps:
a. forming a first mixture comprising:
i. water;
ii. at least one surfactant;
iii. at least one ethylenically unsaturated monomer;
iv. at least one recycled monomer;
v. optionally at least one carboxyl functional monomer;
vi. optionally at least one crosslinking functional or multi-ethylenically unsaturated monomer;
b. polymerizing said first mixture in the presence of at least one polymerization initiator;
c. forming a second mixture comprising:
i. at least the product obtained in the step b;
ii. at least one surfactant;
iii. at least one ethylenically unsaturated monomer;
iv. optionally at least one recycled monomer;
v. optionally at least one crosslinking functional or multi-ethylenically unsaturated monomer; and
d. polymerizing said second mixture in the presence of at least one polymerization initiator to obtain the waterborne polymer composition;
wherein said recycled monomer is recycled styrene or its dimer, or its trimer, and comprises from 100 ppm to 25.000 ppm by weight of ethylbenzene.

13. The process according to claim 11, wherein the polymerization is made by multistage emulsion polymerization, said process comprising the following successive steps:
a. forming a first mixture comprising:
i. water;
ii. at least one surfactant;
iii. at least one ethylenically unsaturated monomer;
iv. optionally at least one recycled monomer;
v. optionally at least one carboxyl functional monomer;
vi. optionally at least one crosslinking functional or multi-ethylenically unsaturated monomer;
b. polymerizing said first mixture in the presence of at least one polymerization initiator;
c. forming a second mixture comprising:
i. at least the product obtained in step b;
ii. at least one surfactant;
iii. at least one recycled monomer;
iv. optionally at least one crosslinking functional or multi-ethylenically unsaturated monomer; and
d. polymerizing said second mixture in the presence of at least one polymerization initiator to obtain the waterborne polymer composition;
wherein said recycled monomer is recycled styrene or its dimer, or its trimer, and comprises from 100 ppm to 25.000 ppm by weight of ethylbenzene.

14. The process according to claim 11, wherein the polymerization is made by multistage emulsion polymerization, said process comprising the following successive steps:
a. forming a first mixture comprising:
i. water;
ii. at least one carboxyl functional monomer;
iii. optionally at least one surfactant;
iv. optionally at least one recycled monomer;
v. optionally at least one crosslinking functional or multi-ethylenically unsaturated monomer;
b. polymerizing said first mixture in the presence of at least one polymerization initiator, to produce a polymeric stabilizer;
c. neutralizing the polymeric stabilizer with at least one neutralizing agent to a pH value in between the range from 7 to 11;
d. forming a second mixture comprising:
i. at least the neutralized polymeric stabilizer obtained in step c;
ii. at least one recycled monomer;
iii. optionally at least one surfactant;
iv. optionally at least one crosslinking functional or multi-ethylenically unsaturated monomer; and
e. polymerizing said second mixture in the presence of at least one polymerization initiator to obtain the waterborne polymer composition;
wherein said recycled monomer is recycled styrene or its dimer, or its trimer, and comprises from 100 ppm to 25.000 ppm by weight of ethylbenzene.

15. A process for producing a waterborne polymer composition
providing a polymer comprising styrene monomer unit;
recycling said polymer in a recycling process to obtain recycled styrene or its dimer, or its trimer that comprises from 100 ppm to 25.000 ppm by weight of ethylbenzene; and
polymerizing said at least one recycled styrene obtained in said recycling process;
wherein the recycling styrene is substantially not purified during the recycling process.

16. A method of producing a coating, paint, primer, ink, varnish, pressure sensitive adhesive, water proofing membrane, sealant, roof coating, redispersible powder, external thermal insulation composite system, tile adhesive, tile grout, repair mortar, self levelling mortar, additive for paper application, paper coating, paper sizing agents, and use of said waterborne polymer composition as textile polymers in finishing, in coating, in adhesive, in flocking, or in nonwoven, or as textile auxiliaries in pretreatment, in dyeing, in printing, or in finishing, or as leather additive in wet end or in finishing, or as additive in construction, or as paper additive, comprising the step of incorporating said waterborne polymer composition according to claim 1.

17. A coating, paint, primer, ink, pressure sensitive adhesive, or varnish, comprising the waterborne polymer composition according to claim 1.
